(19) United States
(12) Patent Application Publication
(10) Pub. No.: US 2013/0233389 A1
(43) Pub. Date: Sep. 12, 2013

(54) HYDRAULIC ACTUATORS

(71) Applicant: Terry Glenn Young, Longview, TX (US)

(72) Inventor: Terry Glenn Young, Longview, TX (US)

(73) Assignee: ARRAY HOLDINGS, INC., Houston, TX (US)

(21) Appl. No.: 13/622,064

(22) Filed: Sep. 18, 2012

Related U.S. Application Data
(60) Provisional application No. 61/608,059, filed on Mar. 7, 2012.

(51) Int. Cl. F16K 31/00

(52) U.S. Cl. 137/1; 251/62

(57) ABSTRACT

Hydraulic valve apparatuses employing the use of multiple pistons for opening and closing gate valves are disclosed. Additionally, hydraulic valve apparatuses with a low profile and without a top shaft are disclosed.

### CROSS REFERENCE TO RELATED APPLICATIONS

This application claims priority to provisional applications 61/608,059 filed Mar. 7, 2012.

### FIELD

The present invention pertains to valves and actuators. More specifically, the present invention pertains to different configurations of hydraulic actuators which are useful in the petroleum industry.

### BACKGROUND

Gate valves are generally comprised of a valve body having a central axis aligned with inlet and outlet passages, and a space between the inlet and outlet passages in which a slide, or gate, may be moved perpendicular to the central axis to open and close the valve. In the closed position, the gate surfaces typically seal against sealing rings which surround the fluid passage through the valve body. Gate valves have been used for centuries to control the flow of a great variety of fluids. Often the fluid to be controlled by the gate valve is under pressure. In the petroleum industry, gate valves are used along piping at various locations, and in particular are used in piping referred to in the petroleum industry as a Christmas tree, which is used as part of a drilling operation.

Actuators to open and close the gate valves may include manual operators, diaphragm-type operators, and hydraulic operators. The actuator may include a bonnet assembly, which interconnects the valve body and the valve gate, and a bonnet stem which is movable with the gate via an operator. The operator typically has a maximum force capability for applying to the bonnet stem. It is sometimes desirable to provide additional opening/closing power on a temporary basis without having to remove the original operator. It is also desirable that the same operator be adaptable to various control accessories, such as a mechanical override, hydraulic override, heat sensitive lock open device, block open cap, electrical limit switch and/or other electrical accessories.

In some cases, it would be desirable, when using hydraulic piston actuators, to relieve stress associated with pushing a large volume of hydraulic fluid against a single piston. Alternatively, it would be desirable to decrease the latitudinal stresses associated with pushing a single piston shaft. Still further, it may be desirable to more finely control the movement of pistons within a hydraulic actuator.

Thus, there has been a long felt need in the industry to provide an improved actuator that decreases stress on the actuator, allows for fine tuning and increases long term durability. Persons skilled in the art will appreciate the present invention which provides solutions to these and other problems associated with valve actuators.

### SUMMARY

Certain embodiments of the invention pertain to an actuator for moving a valve gate between open and closed valve positions within a valve body, the actuator comprising: an actuator housing having a proximal end oriented toward a gate valve and a distal end oriented away from the gate valve; an operator shaft with a distal end and a proximal end, the proximal end extending through a bore of a packing retainer fitted within an internal bore of a bonnet and into the valve body, the bonnet operatively connected to the proximal end of the actuator housing, and the operator shaft defining a shaft axis; a plurality of hydraulic pressure chambers aligned along the shaft axis and separated by at least one piston; a plurality of pistons, each having a piston head and each having a proximal side and a distal side, aligned along the shaft axis and capable of movement in proximal and distal directions within the actuator housing; a hydraulic fluid path connecting one hydraulic pressure chamber to another hydraulic pressure chamber, the fluid path positioned within at least one piston head; a spring having an outer diameter, the spring being capable of producing a biasing force opposing axial movement of the operator shaft toward the valve body; and wherein a change in hydraulic fluid pressure in one hydraulic pressure chamber operatively connected through the fluid path within a piston to another hydraulic pressure chamber results in movement of another piston in a proximal direction or distal direction, and wherein the pistons and the hydraulic pressure chambers are positioned within a cylinder having a hollow interior.

In specific embodiments concerning the fluid path, the piston comprising a fluid path further comprises a proximal piston shaft operatively connected to the fluid path, the proximal piston shaft having a proximal end. Still further, the fluid path may continue through the proximal piston shaft and hydraulic fluid exits the proximal end of the piston shaft.

In further embodiments, the actuator may comprise one or more seals surrounding the piston shaft, wherein hydraulic fluid is prevented from providing a distal force against the proximal side of the piston. In additional embodiments a hydraulic fluid separator plate surrounding the piston and positioned between the piston and the cylinder may be included. In such embodiments, the hydraulic fluid separator plate is affixed to the hollow interior of the cylinder.

In still further embodiments of the invention concerning pistons, a piston not comprising a fluid path may comprise a proximal piston shaft with a proximal end affixed to the operator shaft. Still further, said piston may be operatively connected to a downstop. In embodiments of the invention concerning the downstop, the downstop may be operatively connected to the spring.

In further embodiments of the invention, the spring, the operator shaft and the cylinder are enclosed within an unpressurized housing.

In additional embodiments of the present invention, the actuator comprises a top shaft having a proximal end and a distal end, the distal end extending from the distal end of the cylinder. In such embodiments wherein a top shaft is contemplated, the top shaft may be affixed to a piston having a fluid path.

Additional embodiments pertain to a method of moving a gate valve between an open and closed valve position by a hydraulic actuator, the method comprising: obtaining a hydraulic actuator having a plurality of hydraulic pressure chambers aligned along an axis and separated by at least one piston; the actuator further comprising a plurality of pistons, each having a piston head and each having a proximal side and a distal side, aligned along the axis and capable of movement in proximal and distal directions within the actuator; the actuator further having an operator shaft with a distal end and a proximal end, the proximal end extending through into the valve body, the operator shaft connected to a piston; applying or removing hydraulic pressure from a hydraulic fluid path, the hydraulic fluid path connecting one hydraulic pressure chamber to another hydraulic pressure chamber, the fluid path positioned within at least one piston head; and wherein applying or removing pressure moves the pistons and the operator shaft in a proximal or distal direction, and wherein the operator shaft opens or closes a gate valve.

Further embodiments of the method contemplate that the piston comprising a fluid path further comprises a proximal piston shaft operatively connected to the fluid path, the proximal piston shaft having a proximal end. In such embodiments, the fluid path may continue through the proximal piston shaft such that hydraulic fluid exits the proximal end of the piston shaft.

In still further embodiments of the method a piston not comprising a fluid path may comprise a proximal piston shaft with a proximal end affixed to the operator shaft.

Further, in certain embodiments of the method, upon application of hydraulic pressure, the operator shaft opens or closes a gate valve. In an opposite manner, removal of hydraulic pressure, a spring being capable of producing a biasing force opposing axial movement of the operator shaft toward the valve body moves the operator shaft in a distal direction.

In additional embodiments, the piston comprising a fluid path may remain stationary upon application of hydraulic pressure and a piston not comprising a fluid path moves in a distal direction.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a cross sectional illustration of a dual piston hydraulic actuator.

FIG. 2 is a cross sectional illustration of an operator shaft and valve assembly of a dual piston hydraulic actuator.

FIG. 3 is a cross sectional illustration of an alternate dual piston hydraulic actuator.

FIG. 4 is a cross sectional illustration of a single piston hydraulic actuator with components which may be adapted for use in a dual piston hydraulic actuator.

### LIST OF REFERENCE NUMERALS

10 top shaft

20 polypack seals and threaded member

30 cylinder

40 hydraulic pressure ports

50 milled slot

55 pressure chamber

60 polypack seal

65 upper piston head

70 ware bearings

80 upper piston

85 proximal upper piston shaft

90 hydraulic fluid path

93 external pressure plate seal

95 internal pressure plate seal

97 separator plate bolts

100 separator plate

103 lower pressure chamber

105 separator plate bores

110 lower piston

112 lower piston head

114 proximal lower piston shaft

118 lower piston sleeve

120 spring retainer ring

122 lower piston sleeve retainer ring

124 housed region of the cylinder

130 downstop

140 central spring

150 threaded bore

160 housing

170 bonnet ring

180 bonnet ring bore

200 bonnet

210 valve assembly

220 bonnet bore

230 packing retainer

240 operator shaft

300 top plug

310 lower cylinder

320 threaded joint

325 hydraulic pressure ports

330 upper pressure chamber

340 hydraulic pressure path

350 upper piston

360 lower pressure chamber

370 lower piston

400 single piston

410 threaded partial bore

420 operator shaft

430 downstop

### DETAILED DESCRIPTION

Introduction

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings making apparent to those skilled in the art how the several forms of the invention may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3rd Edition.

Distal, in certain instances, can be defined as toward the top of the actuator and away from any valve on which the actuator rests.

Proximal, in certain instances, can be defined as toward a valve on which an actuator is mounted and away from the top of the actuator.

Stainless steel, in certain instances, can be defined as any iron alloy generally resistant to oxidation.

Hydraulic, in certain instances, can be defined as a fluid which can be placed under pressure in order to move parts of mechanical devices. Examples of hydraulic fluids include, but are not limited to water, oils, colloidal suspensions, alcohols and the like. Commercially available hydraulic fluids are readily available.

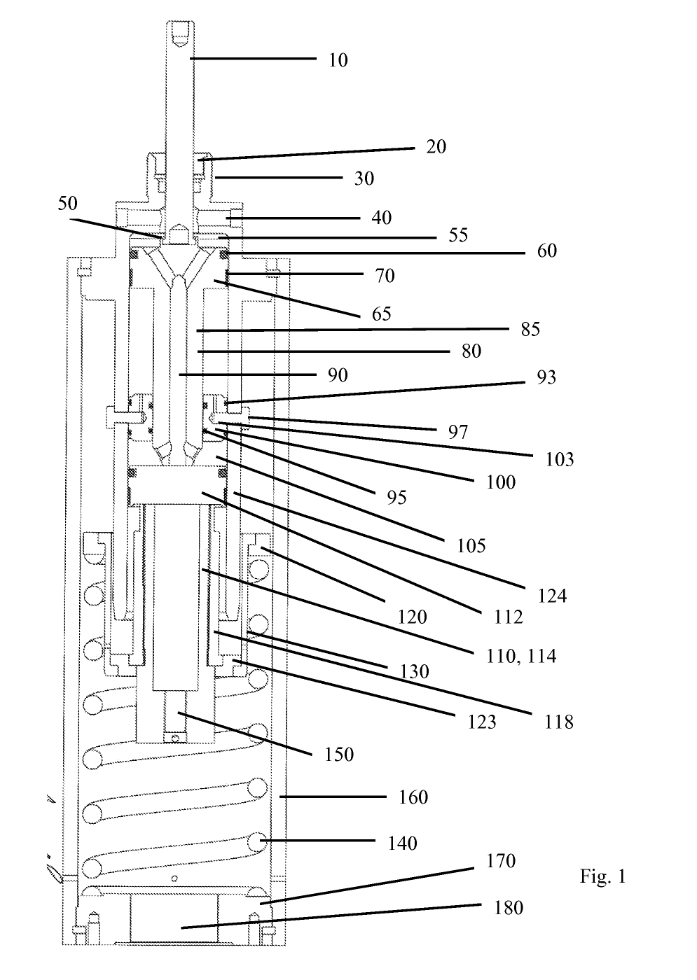

Referring to FIG. 1, the actuator has a top shaft 10 slidably disposed in a cylinder 30 where the top shaft 10 is sealed with a polypack seals and a threaded retainer 20.

A typical cylinder 30 can be between about 10 inches to about 30 inches in diameter. The shape is generally cylindrical and can be made from strong metal alloys, ceramics and the like. In preferred embodiments, the cylinder is made of stainless steel with about a ¼ to ½ inch thickness.

Still further as illustrated in FIG. 1, the cylinder 30 has hydraulic pressure ports 40. Optionally, one of the hydraulic pressure ports is sealed with a bust disc. The burst disc may be set at a pressure necessary to both result in pushing of the piston downward but yet avoiding damage due to too much pressure within the hydraulic fluid path 90 as discussed below. For instance, the burst disc may be set at a pressure of 50 psi, 100 psi, 200 psi, 300 psi, 400 psi, 500 psi, 600 psi, 700 psi, 800 psi, 900 psi, 1000 psi, 2000 psi, 4000 psi, 5000 psi, 6000 psi, 7000 psi, 8000 psi, 9000 psi 10,000 psi or greater or some amount in between the aforementioned pressure points.

Below the hydraulic pressure ports 40, is the flanged region of the top shaft which is held to the upper piston 80 by way of a milled slot 50. As can be viewed by the FIG. 1 illustration, the upper piston fits within the cylinder 30 and abuts the inner walls of the cylinder 30. In alternative embodiments, the flanged region of the top shaft can be bolted, or secured via a threaded nut capable of threading into the piston and retaining or securing the flanged region of the top shaft.

The top shaft can be generally large enough in diameter to prevent buckling under stresses when loaded by a manual override or hydraulic overrides.

Polypack seals 60 and ware bearings 70 help make the upper piston both sealed within the cylinder 30 and slidably disposed within the cylinder 30.

With detail being drawn to FIG. 1, the upper piston 80, may be comprised of an incompressible material capable of moving a valve or other piston upon pressure from the upper pressure chamber 55. Typical materials which are envisioned to be used in the construction of the upper piston 80 include stainless steels, durable ceramics and the like. The upper piston 80 typically possesses an upper piston head 65 and a proximal upper piston shaft 85, extending in a proximal direction from the upper pressure receiving region.

The upper piston 80 extends in a proximal direction with the upper piston shaft 85 as discussed above. The upper piston 80 further comprises a hydraulic fluid path 90 which allows hydraulic fluid to flow from the upper pressure chamber 55, through the upper piston 80 and the proximal upper piston shaft 65 and into the lower pressure chamber 105, which causes hydraulic fluid to not only accumulate above the upper piston 80, but also between the upper piston and the lower piston 110.

A separator plate 100 with pins prevents hydraulic fluid from the lower pressure chamber from traveling distally to the upper piston. This prevents an upward or distal force acting against the upper piston when an operator is attempting to move one or both pistons in a proximal direction. The separator plate possesses at least one external pressure plate seal 93 and at least one internal pressure plate seal 95 which contacts the proximal upper piston shaft 65. Typically these seals are polypack seals or o-rings. In general, the separator plate 100 is affixed to the inner bore of the cylinder 30. The method of affixing the separator plate to the cylinder 30 may include welding, riveting, pinning or in preferable embodiments through the use of a plurality of separator plate bolts 97. In general, the separator plate bolts 97 will extend through the cylinder in a substantially horizontal position which is perpendicular to the axis of the upper piston shaft 85. The separator plate bolts 97 may be threaded and the separator plate 100 may have separator plate bores 103 which are also threaded and adapted to receive the separator plate bolts. The separator plate and seals are intended to prevent hydraulic fluid from exiting the proximal piston upper piston shaft 85 and traveling in a distal direction to the upper piston head 65 and applying unwanted pressure which would prevent the upper piston head from traveling in a proximal direction.

Still referring to FIG. 1, like the upper piston 80, the lower piston 110 is slidably disposed within the cylinder 30. The lower piston 100 comprises a lower piston head 112 and a proximal lower piston shaft 114. However, unlike the upper piston 80, the lower piston 100 does not possess a hydraulic fluid path 90. Like the upper piston 80, the lower piston 110 can be made out of any hard durable material such as stainless steels, durable ceramics and the like. Regarding the lower piston head 112, between the cylinder 30 and the lower piston head 112 are polypack seals 60 and ware bearings 70. Typically, indentations in the lower piston head are designed to accommodate polypack seals 60 and ware bearings 70. These enable movement of the lower piston 110 upon pressure from the upper piston 80 or the lower pressure chamber 105 without leakage of hydraulic fluid.

Regarding the lower piston 110, the lower piston shaft 114 possesses a lower piston partial bore 150 at its proximal end. The lower piston partial bore 150 is adapted to receive an operator shaft. Typically, the lower piston is a threaded bore adapted to receive a threaded operator shaft. However, it is conceivable that the operator shaft may be affixed to the lower piston shaft 114 in a different manner.

At least partially surrounding the proximal lower piston shaft 114, and with an outer diameter less than the inner diameter of the cylinder 30, is a lower piston sleeve 118. Downward or proximal movement of the lower piston 110 due to hydraulic pressure or pressure from the upper piston 80 in turn forces a downward or proximal movement at the junction between the lower piston head 112 and the lower piston sleeve 118, resulting in a downward or proximal movement of the lower piston sleeve 118.

The lower piston sleeve 118 is in physical connection with the lower piston sleeve retainer ring 122. Also in physical connection with the lower piston sleeve retainer ring 112 is the downstop 130. The downstop 130, like the lower piston sleeve, can be made of any rigid durable material such as stainless steel or a ceramic. Further, the outer sleeve has an inner diameter greater than the outer diameter of the housed region of the cylinder 124 contained within the actuator housing. The outer sleeve at least partially surrounds the housed region of the cylinder 124. Still further, as the downstop abuts or is in physical connection with the lower piston sleeve retainer ring 122 at its proximal end, it is also in physical connection with an upper spring retainer ring 120 at its distal end

The central spring 140 possesses a distal end and a proximal end. The distal end of the central spring 140 contacts the spring retainer ring 120, while the proximal end of the central spring contacts the bonnet ring 170. The cylinder, spring and downstop are housed in an actuator housing 160. The actuator housing is preferably made of a rigid material such as a stainless steel. Further, the actuator housing 160 extends, at its proximal end, past the bonnet ring 170 such that the outer diameter of the bonnet ring 170 is less than the inner diameter of the actuator housing 160. In such embodiments, the actuator housing may be bolted to the bonnet ring or threaded to the bonnet ring. The bonnet ring further possesses a bonnet ring bore 180.

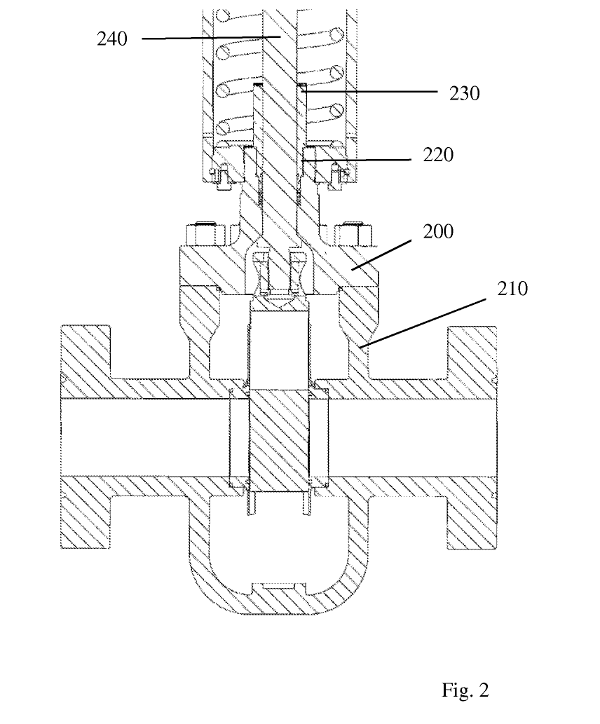

The bonnet ring bore is adapted to receive a bonnet 200 as illustrated in FIG. 2 is preferably connected to a valve assembly 210. The bonnet ring bore 180 of FIG. 1 is preferably threaded and adapted to receive reciprocal threading on the bonnet 200 of FIG. 2. The bonnet also possesses a bonnet bore 220 adapted to receive an internal packing retainer 230. The bonnet bore is preferably threaded and adapted to receive reciprocal threading on the exterior of the packing retainer 230. The packing retainer also has a packing retainer bore through which the operator shaft 240 may extend from the lower piston to the valve assembly 210 of FIG. 2.

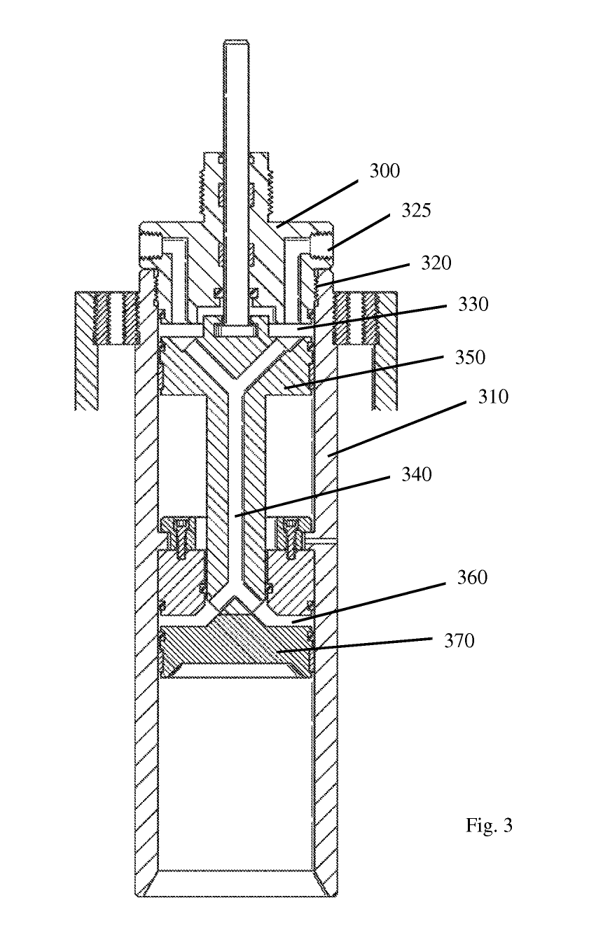

An alternate embodiment of the present invention is illustrated in FIG. 3 wherein the cylinder is separated into a top plug 300 and a lower cylinder 310. In this embodiment, the top plug 300 is threaded into the lower cylinder at a threaded joint 320. Like the previous embodiment, hydraulic pressure ports 325 present. Also, like the previous figure, the upper piston possesses an upper pressure chamber 330, a hydraulic pressure path 340, an upper piston 350, a lower pressure chamber 360 and a lower piston 370. The lower piston can be adapted to manipulate a downstop and an actuator spring as well as an operator shaft in a fashion similar or equivalent to that illustrated in FIG. 1.

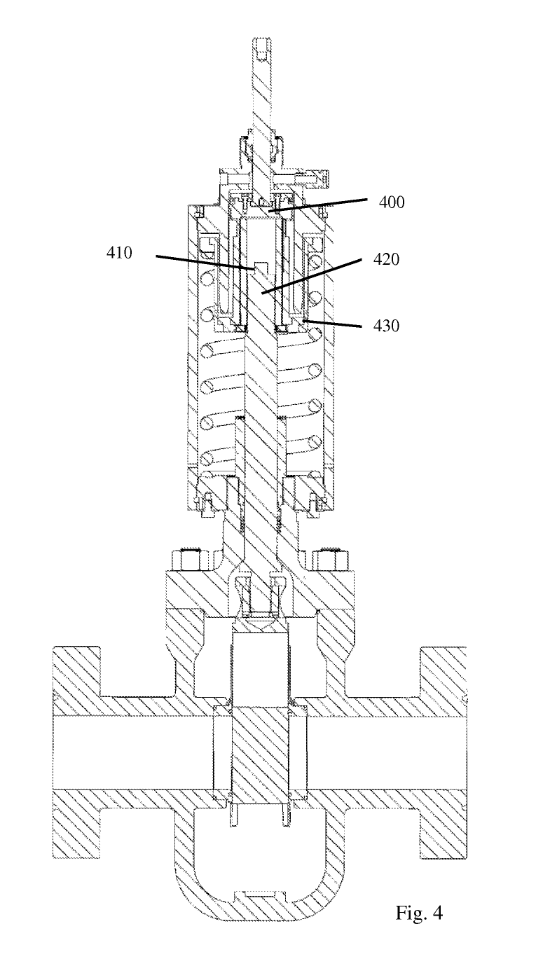

FIG. 4 is an illustration of a single hydraulic piston actuator. However, this actuator has certain elements that may also be found in the dual piston actuator. Namely, the single piston 400, possesses a threaded partial bore 410 adapted to receive an operator shaft 420. The piston is further in communication with a downstop 430 to compress the spring.

All of the apparatuses and/or methods disclosed and claimed herein can be made and executed without undue experimentation in light of the present disclosure. While the apparatuses and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. More specifically, it will be apparent that certain components which are both structurally or functionally related may be substituted for the components described herein while the same or similar results would be achieved. All such similar substitutes and modifications apparent to those skilled in the art are deemed to be within the spirit, scope and concept of the invention as defined by the appended claims.

1. An actuator for moving a valve gate between open and closed valve positions within a valve body, the actuator comprising:
a. an actuator housing having a proximal end oriented toward a gate valve and a distal end oriented away from the gate valve;
b. an operator shaft with a distal end and a proximal end, the proximal end extending through a bore of a packing retainer fitted within an internal bore of a bonnet and into the valve body, the bonnet operatively connected to the proximal end of the actuator housing, and the operator shaft defining a shaft axis;
c. a plurality of hydraulic pressure chambers aligned along the shaft axis and separated by at least one piston;
d. a plurality of pistons, each having a piston head and each having a proximal side and a distal side, aligned along the shaft axis and capable of movement in proximal and distal directions within the actuator housing;
e. a hydraulic fluid path connecting one hydraulic pressure chamber to another hydraulic pressure chamber, the fluid path positioned within at least one piston head; and
wherein a change in hydraulic fluid pressure in one hydraulic pressure chamber operatively connected through the fluid path within a piston to another hydraulic pressure chamber results in movement of another piston in a proximal direction or distal direction, and wherein the pistons and the hydraulic pressure chambers are positioned within a cylinder having a hollow interior.

2. The actuator of claim 1, wherein the piston comprising a fluid path further comprises a proximal piston shaft operatively connected to the fluid path, the proximal piston shaft having a proximal end.

3. The actuator of claim 2, wherein the fluid path flows continues through the proximal piston shaft and hydraulic fluid exits the proximal end of the piston shaft.

4. The actuator of claim 2, further comprising one or more seals surrounding the piston shaft, wherein hydraulic fluid is prevented from providing a distal force against the proximal side of the piston.

5. The actuator of claim 4, further comprising a hydraulic fluid separator plate surrounding the piston and positioned between the piston and the cylinder.

6. The actuator of claim 5, wherein the hydraulic fluid separator plate is affixed to the hollow interior of the cylinder.

7. The actuator of claim 1, wherein a piston not comprising a fluid path comprises a proximal piston shaft with a proximal end affixed to the operator shaft.

8. The actuator of claim 1, further comprising a spring having an outer diameter, the spring being capable of producing a biasing force opposing axial movement of the operator shaft toward the valve body.

9. The actuator of claim 8, wherein a piston not comprising a fluid path is operatively connected to a downstop.

10. The actuator of claim 9, wherein the downstop is operatively connected to the spring.

11. The actuator of claim 10, wherein the spring, the operator shaft and the cylinder are enclosed within an unpressurized housing.

12. The actuator of claim 1, further comprising a top shaft having a proximal end and a distal end, the distal end extending from the distal end of the cylinder.

13. The actuator of claim 12, wherein the top shaft is affixed to a piston having a fluid path.

14. A method of moving a gate valve between an open and closed valve position by a hydraulic actuator, the method comprising:
a. obtaining a hydraulic actuator having a plurality of hydraulic pressure chambers aligned along an axis and separated by at least one piston; the actuator further comprising a plurality of pistons, each having a piston head and each having a proximal side and a distal side, aligned along the axis and capable of movement in proximal and distal directions within the actuator; the actuator further having an operator shaft with a distal end and a proximal end, the proximal end extending through into the valve body, the operator shaft connected to a piston;
b. applying or removing hydraulic pressure from a hydraulic fluid path, the hydraulic fluid path connecting one hydraulic pressure chamber to another hydraulic pressure chamber, the fluid path positioned within at least one piston head; and
wherein applying or removing pressure moves the pistons and the operator shaft in a proximal or distal direction, and wherein the operator shaft opens or closes a gate valve.

15. The method of claim 14, wherein the piston comprising a fluid path further comprises a proximal piston shaft operatively connected to the fluid path, the proximal piston shaft having a proximal end.

16. The method of claim 15, wherein the fluid path flows continues through the proximal piston shaft and hydraulic fluid exits the proximal end of the piston shaft.

17. The method of claim 14, wherein a piston not comprising a fluid path comprises a proximal piston shaft with a proximal end affixed to the operator shaft.

18. The method of claim 17, wherein upon application of hydraulic pressure, the operator shaft opens or closes a gate valve.

19. The method of claim 17, wherein upon removal of hydraulic pressure, a spring being capable of producing a biasing force opposing axial movement of the operator shaft toward the valve body moves the operator shaft in a distal direction.

20. The method of claim 14, wherein the piston comprising a fluid path remains stationary upon application of hydraulic pressure and a piston not comprising a fluid path moves in a distal direction.
